(19) United States
(12) Patent Application Publication
(10) Pub. No.: US 2008/0218044 A1
(43) Pub. Date: Sep. 11, 2008

(54) Attached File Hanging Folders

(76) Inventors: Juan Carlos Unda, Whittier, CA (US); Miguel Angel UndaLuquin, Whittier, CA (US)

Correspondence Address: WILSON DANIEL SWAYZE, JR., 3804 CLEARWATER CT., PLANO, TX, 75025, US

(21) Appl. No.: 11/684,597

(22) Filed: Mar. 10, 2007

(51) Int. Cl. B42F 15/00

(52) U.S. Cl. 312/321

(57) ABSTRACT

A file device for mounting onto a support rail includes a first sheet having a first support device to cooperate with the support rail along a top edge of the first sheet, a second sheet having a second support device to cooperate with the support rail along a top edge of the second sheet and being coupled to the first sheet along the bottom of the second sheet and a third sheet having a third support device to cooperate with the support rail along the top edge of the third sheet and being coupled to the second sheet along the top of the third sheet.

### TECHNICAL FIELD

The present invention relates to office supplies and, in particular, to hanging folders which assist for filing files on drawers or file racks.

### BACKGROUND ART

Hanging folders, for use in standard storage units such as file cabinets, desk drawers and the like, are a necessary tool in modern offices and businesses. Such folders in the art are best exemplified by expired U.S. Pat. No. 2,291,724. This reference describes a file formed by a sheet of heavy material with a central horizontal fold which forms the folder's bottom and open sides. Folds are provided in the file's top edges through which hanging rods are movably or immovably fixed. The ends of these rods are exposed and notched, enabling the file to hang on a complementary standard parallel file frame in office storage equipment, such as filing cabinets and desk drawers.

The inner surfaces at the tops of the folded-over portions contain uniformly spaced slots for insertion of labeling tabs. These slots often tear or wear out as new tabs are inserted or removed, due to the need for frequent file relabeling or repositioning of labels in alternative slots of the file. Also, when the user inserts the tabs of the label into the slots, close attention is required because the opening of the slot and the material behind it are generally identical in color.

U.S. Pat. No. 4,749,121 discloses a hanging folder with a reinforcing plastic film applied to the side edges to reduce wear on the side of the file as it is moved in the frame. This film may be applied with colored adhesive to provide a color coding system or a clear film may be applied over a colored surface by a clear adhesive to achieve the same result. Similar side reinforcing techniques are disclosed in U.S. Pat. Nos. 4,523,776 and 4,580,815.

When hanging files are filled with a large volume of paper, the sides tend to spread away from each other and the bottom lifts.

This causes problems for people filing files with separate file hanging folders. With the sides tending to spread away from each other, this provides an opening for the file to fall out of the folder. This of course can cause problems for the users of the folders because the files may quickly become disorganized. Furthermore, the folders for the files may come off the supports altogether. In a similar fashion, this may cause problems for the users because the folder and file could falls to the floor or to the bottom of the file cabinet.

### SUMMARY

A file device for mounting onto support rails includes a first sheet having a first support device to cooperate with the support rail along a top edge of the first sheet, a second sheet having a second support device to cooperate with the support rail along a top edge of the second sheet and being coupled to the first sheet along the bottom of the second sheet and a third sheet having a third support device to cooperate with the support rail along the top edge of the third sheet and being coupled to the second sheet along the top of the third sheet.

The file device includes a fourth sheet having a fourth support device to cooperate with the support rail along the top edge of the fourth sheet and being coupled to the third sheet along the bottom of the third sheet.

The first sheet and the second sheet may be substantially V-shaped or U-shaped.

The third sheet and the fourth sheet may be substantially U-shaped or V-shaped

The first sheet, the second sheet, the third sheet and the fourth sheet may be flexible.

The first sheet, the second sheet, the third sheet in the fourth sheet may be rigid.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of a file drawer and the hanging folders of the present invention;

FIG. 2 illustrates a perspective view of the support rail, dividers and hanging folders of the present invention;

FIG. 3 illustrates a perspective view of the hanging folders of the present invention;

### DETAILED DESCRIPTION

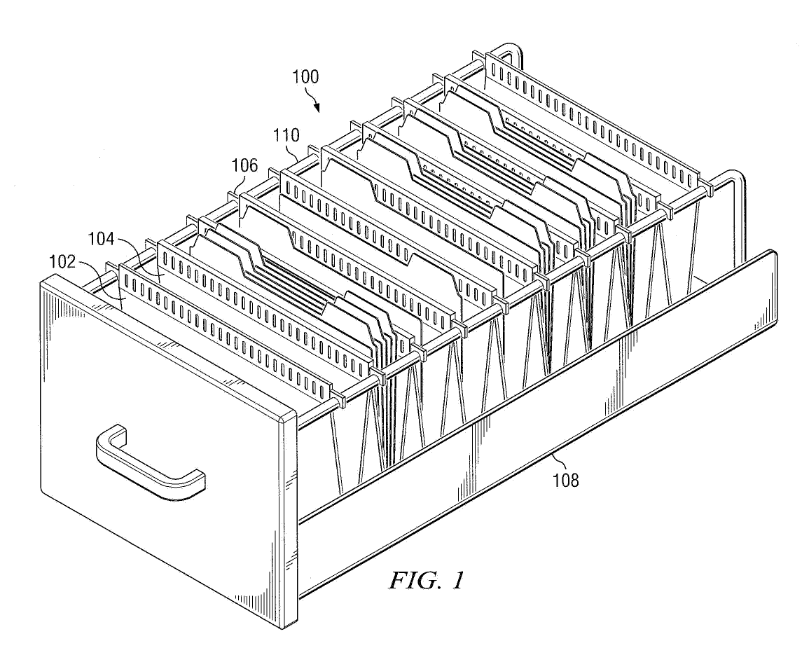

FIG. 1 illustrates a continuous hanging folder and illustrates a substantially V-shaped folder 100 which includes a first sheet 102 and a second sheet 104 which is affixed or integrally folded with the first flexible sheet 102. The V-shaped folder additionally includes a support device 106 which may be integral with or may be attached along the top edge of the first and second sheet 102, 104. The support device 106 extends beyond the first and second flexible sheet 102, 104 and includes an inverted notch on each end of the support device 106 in order to engage in cooperate with the support rail 110 which may extend from front to back or side to side of the drawer 108.

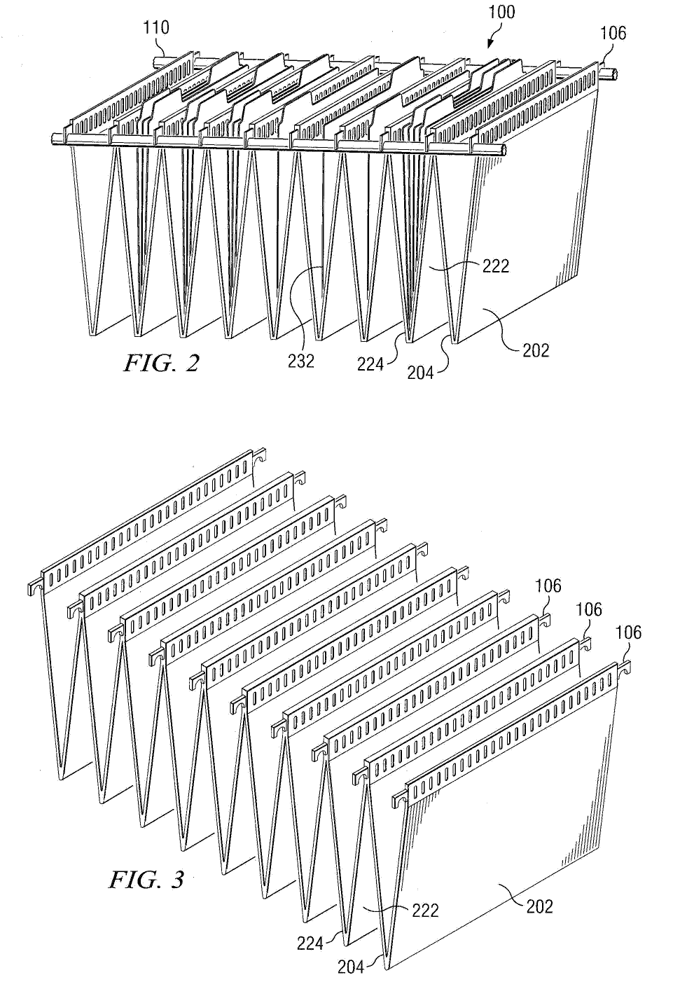

FIG. 2 illustrates a continuous folder 200 in accordance with the teachings of the present invention. The present invention describes a series of sheets which may be attached at the top and bottom for example with adhesive or may be integral with the adjacent sheet and folded. The present invention includes all of these embodiments and refers to coupling to encompass all of these embodiments.

FIG. 2 illustrates a first sheet 202 which may be flexible or rigid and sized to fit between the support rails 110 and should extend downwards without touching the bottom of the drawer 108. FIG. 2 additional illustrates a second sheet 204 which may be flexible or rigid and sized to fit between the support rails 110 and should extend downwards without touching the bottom of the drawer 108. The first sheet 202 is coupled to the second sheet 204 along the bottom edge of the sheets 202, 204. Each of the first sheet 202 and the second sheet 204 includes a support device 106 which extends along the top edge of the first sheet 202 and the second sheet 204. The support device 106 includes a notch for traveling on the support rail 110 which extends from the front to the back of the drawer 108.

FIG. 2 additional illustrates a third sheet 222 which may be flexible or rigid and sized to fit between the support rails 110 and which is coupled to the second sheet 204 along the top edge of the third sheet 222 and a top edge of the second sheet 204. The third sheet the 222 includes a support device 106 which extends along the top edge of the third sheet 222. FIG. 2 illustrates that the third sheet 222 is coupled to a fourth sheet 224 along the bottom of the third sheet 222 and the fourth sheet 224. The fourth sheet 224 which may be flexible or rigid and sized to fit between the support rails 110 and coupled to the third sheet 222 along the bottom of the third sheet 222. The number of the first, second, third, and four sheets can be extended to accommodate the needs of the user. However, the principles of alternating the coupling of the sheets 202, 204, 222, 224 along the top edge and then coupling the sheets along the bottom edge can be repeated accordance with the needs of the user. FIG. 2 additionally illustrates that a divider sheet 232 which may be flexible or rigid can be placed between the first sheet 202 and a second sheet 204 or between the third sheet 222 and the fourth sheet 224. To divide files or other needs of the user. The first sheet, the second sheet, the third sheet, the fourth sheet and the divider sheet may be formed from plastic, paper, cardboard or any other suitable material.

The above relationship tends to eliminate the propensity of the support device 106 to travel along the support rails 110.

As illustrated, the first sheet 202 and the second sheet 204 may be V-shaped; however, the first sheet 202 in the second sheet may be U-shaped to accommodate larger files. Likewise, the third sheet 222 and the fourth sheet 224 may be V-shaped or U-shaped. The first sheet 202 and the second sheet 204 may be V-shaped while the third sheet 222 and the fourth sheet 224 may be U-shaped and vice versa.

The present invention provides for more stable file retention. The present invention retains the contents within the folder and the contents of the folder does not fall out.

FIG. 3 illustrates the continuous folder with dividers 232.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A file device for mounting onto a support rail, comprising:
a first sheet having a first support device to cooperate with the support rail along a top edge of the first sheet,
a second sheet having a second support device to cooperate with the support rail along a top edge of the second sheet and being coupled to the first sheet along the bottom of the second sheet;
a third sheet having a third support device to cooperate with the support rail along the top edge of the third sheet and being coupled to the second sheet along the top of the third sheet.

2. A file device for mounting onto a support rail as in claim 1, wherein the first sheet and the second sheet are substantially V-shaped.

3. A file device for mounting onto a support rail as in claim 1, wherein the second sheet and the third sheet are substantially U-shaped.

4. A file device for mounting onto a support rail as in claim 1, wherein the file device includes a fourth sheet having a fourth support device to cooperate with the support rail along the top edge of the fourth sheet and being coupled to the third sheet along the bottom of the third sheet.

5. A file device for mounting onto a support rail as in claim 4, wherein said third sheet and said fourth sheet are substantially V-shaped.

6. A file device for mounting onto a support rail as in claim 4, wherein said third sheet and said fourth sheet are substantially U-shaped.

7. A file device for mounting onto a support rail as in claim 1, wherein said first sheet is flexible.

8. A file device for mounting onto a support rail as in claim 1, wherein said first sheet is rigid.

9. A file device for mounting onto a support rail as in claim 1, wherein said second sheet is flexible.

10. A file device for mounting onto a support rail as in claim 1, wherein said second sheet is rigid.

11. A file device for mounting onto a support rail as in claim 1, wherein said third sheet is flexible.

12. A file device for mounting onto a support rail as in claim 1, wherein said third sheet is rigid.

13. A file device for mounting onto a support rail as in claim 1, wherein said fourth sheet is flexible.

14. A file device for mounting onto a support rail as in claim 4, wherein said fourth sheet is rigid.
